(19) United States
(12) Patent Application Publication
(10) Pub. No.: US 2005/0288042 A1
(43) Pub. Date: Dec. 29, 2005

(54) Method of combining and showing short messages sent to or received from a telephone number

(75) Inventors: Cheng-Shing Lai, Taipei Hsien (TW); Jing-Song Wu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,186

(22) Filed: Jun. 23, 2004

(51) Int. Cl. H04Q 7/20

(52) U.S. Cl. 455/466; 455/412.1; 455/414.1

(57) ABSTRACT

The present invention is to provide a method of combining and showing short messages sent to or received from a telephone number, which comprises the steps of configuring the cellular phone to sequentially combine a plurality of short messages sent to or received from the telephone number based on time of occurring; storing the combination in a memory of the cellular phone; reading the combination from the memory for reviewing contents of the short messages according to the corresponding telephone number; and showing the contents of the combined short messages on a display of the cellular phone.

### FIELD OF THE INVENTION

The present invention relates to cellular phones, more particularly to a method of combining short messages sent to or received from a telephone number and showing the combinations sequentially on the display of a cellular phone in order to easily obtain all short messages relating to the telephone number.

### BACKGROUND OF THE INVENTION

This is an information age as time evolves. Also, electronics industry and its associated industries have known a rapid, spectacular development. All kinds of high-technology products and communication products related to computer technology are commercially available. Increasingly, more and more compact, multi-functional, and inexpensive high-technology products and mobile communication products are commercially available and are very popular. For example, cellular phones and PDAs (Personal Digital Assistants) are closely related to our daily life and work. Their increasing popularity shortens time required for communicating between two distant users. In addition, people have an increasing demand to the features and quality of the mobile communication products as they are available in an even faster pace. Thus, an indicator about whether the manufacturing technology of the mobile communication products is more advanced can be decided by whether a convenient service, a more effective operation, and more powerful features can be provided by the mobile communication products.

Currently, short messages are received or sent one at a time (i.e., one by one) when short messages are transmitted by a cellular phone. Thus, a user has to open the received short message and read the same one at a time. However, since the data transfer rate of a wireless network (e.g., WAP (Wireless Application Protocol)) is low, it is typical to have a time delay of several minutes between a previously received short message and a currently received short message transmitted by a cellular phone. A user may be confused by a previously received short message and a currently received short message if a plurality of short messages were received by his/her cellular phone. The user has to carefully check contents of all received short messages in order to distinguish which short messages are sent to or received from one telephone number and know the contents of a plurality of short messages sent to or received from the same telephone number. This is a tedious and time consuming process. Thus, the need for improvement exists.

### SUMMARY OF THE INVENTION

A primary object of the present invention is to provide a method of combining and showing short messages sent to or received from a telephone number, the method comprising configuring the cellular phone to sequentially combine a plurality of short messages sent to or received from the telephone number based on time of occurring; storing the combination in a memory of the cellular phone; reading the combination from the memory for reviewing contents of the short messages according to the corresponding telephone number; and showing the contents of the combined short messages on a display of the cellular phone. By utilizing the present invention, a user may review the combined short messages in a complete listing for quickly knowing the contents of all short messages corresponding to a specific telephone number. Further, the above drawback of the prior art can be overcome. The drawback is that a user may be confused by a previously received short message and a currently received short message if a plurality of short messages were received by his/her cellular phone.

In one aspect of the present invention, the cellular phone comprises a combination option for selecting a short message combination and showing mode or a typical short message showing mode, the method further comprising responsive to selecting the short message combination and showing mode, inputting a telephone number for the combination and showing; configuring the cellular phone to sequentially combine short messages sent to or received from the telephone number based on time of occurring; storing the combination in the memory of the cellular phone; reading the combination from the memory for reviewing contents of the short messages according to the corresponding telephone number; and showing the contents of the combined short messages on the display; and responsive to selecting the typical short message showing mode, sequentially showing the short messages sent to or received from any telephone numbers on the display based on time of occurring.

The above and other objects, features and advantages of the present invention will become apparent from the following detailed description taken with the accompanying drawings.

### BRIEF DESCRIPTION OF THE DRAWINGS

FIG. 1 is a block diagram of the control circuitry of a cellular phone according to the invention; and

FIG. 2 is a flow chart according to the invention.

### DETAILED DESCRIPTION OF THE PREFERRED EMBODIMENTS

The invention is directed to a method of combining and showing short messages sent to or received from a telephone number, the method comprises the steps of configuring the cellular phone to sequentially combine short messages sent to or received from the telephone number based on time of occurring; storing the combination in a memory (e.g., flash memory) of the cellular phone; reading the combination from the memory for reviewing contents of the short messages according to the corresponding telephone number; and showing the contents of the combined short messages on a display (e.g., LCD (liquid crystal display)) of the cellular phone. By configuring as above, a user may review the combined short messages in a complete listing for quickly knowing the contents of all short messages corresponding to a specific telephone number.

In the invention, the cellular phone comprises a combination option so that a user may select a short message combination and showing mode or a typical short message showing mode. In a case of the short message combination and showing mode being selected, a user may input a telephone number into a cellular phone (i.e., called party) for short message combination and showing the same thereafter. The cellular phone then sequentially combines short messages sent to or received from the telephone number based on time of occurring and stores the combination in a memory of the cellular phone. In a case of reviewing the contents of combined short messages, the cellular phone reads the combined short messages from the memory of the cellular phone according to the corresponding telephone number, and then sequentially shows the contents of combined short messages on the display of the cellular phone as illustrated in an example below:

0918123456 (9/30 19:06): How are you? Do you have time tonight?

Called party (9/30 19:16): No time.

0918123456 (9/30 19:28): When will you have time?

Called party (9/30 19:41): Never.

In a case of the typical short message showing mode being selected, short messages sent to or received from any telephone numbers in a cellular phone (i.e., called party) are sequentially shown on the display of the cellular phone based on time of occurring as illustrated in an example below.

0918123456 (9/30 19:06): How are you? Do you have time tonight?

Called party (9/30 19:16): No time.

0915456123 (9/30 19:17): Would you lend me your notebook computer?

Called party (9/30 19:20): No. I will use the notebook computer in tomorrow's class?

0925789456 (9/30 19:23): Would you come with me to SOGO department store? It is on sale.

Called party (9/30 19:25): OK. When?

0925789456 (9/30 19:27): Now.

0918123456 (9/30 19:28): When will you have time?

Called party (9/30 19:41): Never.

0955123789 (9/30 20:30): Would you lend me your notebook? I have an examination tomorrow.

Called party (9/30 20:39): OK. You can come to my home to take it.

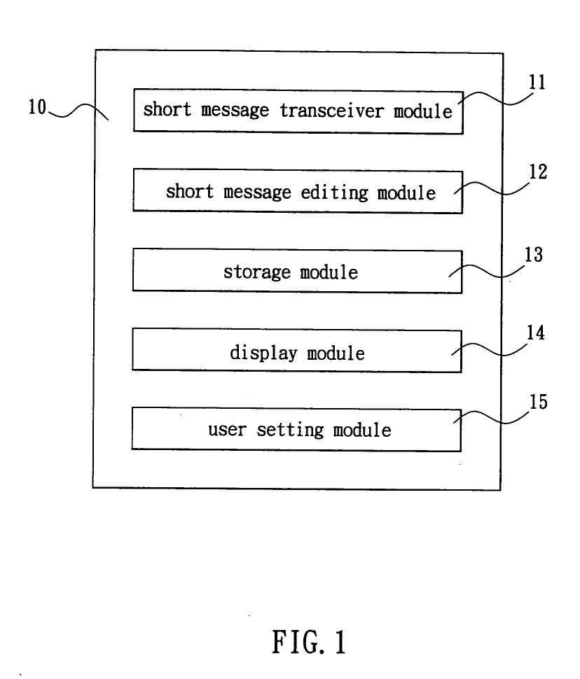

Referring to FIG. 1, there is shown a block diagram of a control circuitry 10 of a cellular phone. The control circuitry 10 comprises a short message transceiver module 11, a short message editing module 12, a storage module 13, a display module 14, and a user setting module 15. The short message transceiver module 11 is used by the cellular phone to send or receive short messages. A user may activate the short message editing module 12 to edit a short message. The storage module 13 is implemented as a memory of the cellular phone for storing short messages sent or received by the cellular phone. The display module 14 is implemented as a display of the cellular phone for showing short messages sent or received by the cellular phone. The user setting module 15 is implemented as a combination option so that a user may select a short message combination and showing mode or a typical short message showing mode from the combination option.

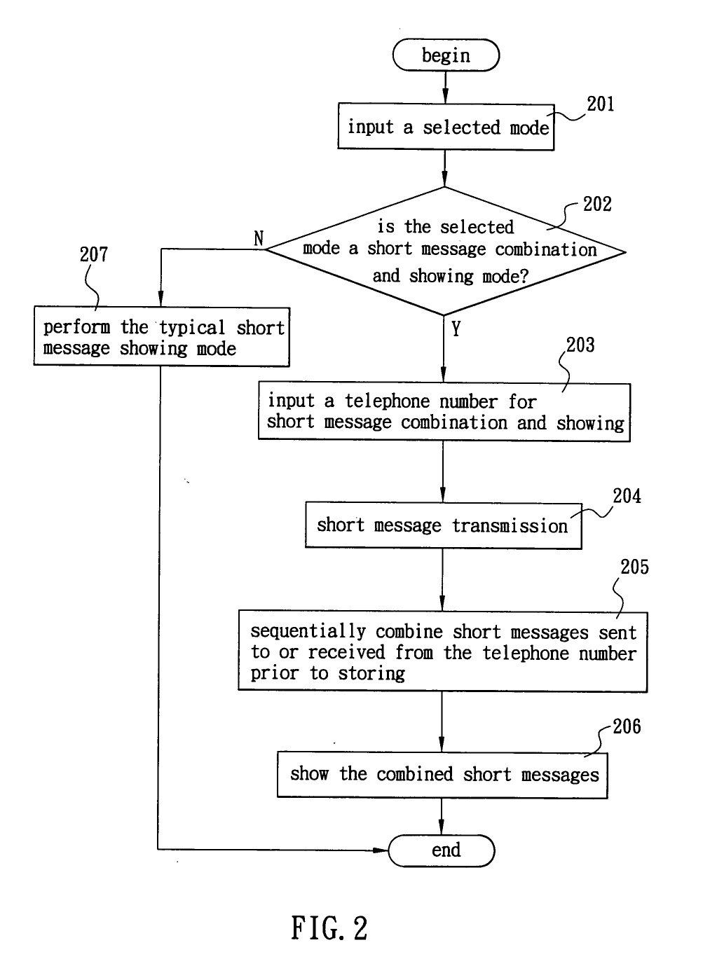

Referring to FIG. 2, there is shown a process including steps performed by a cellular phone when a short message is sent to or received from a telephone number. These steps are as follows.

In step 201, a combination option is shown on the display so that a user may select a short message combination and showing mode or a typical short message showing mode therefrom.

In step 202, after the mode being selected, it is determined whether the selected mode is the short message combination and showing mode or not. If yes, the process goes to step 203. Otherwise, the process jumps to step 207.

In step 203, the cellular phone prompts a dialog box for user to input a telephone number for combining and showing the short messages, and then stores the telephone number being inputted as the telephone number for combining and showing the short messages.

In step 204, the cellular phone proceeds with short messages transmission with respect to the telephone number.

In step 205, the cellular phone (i.e., called party) is configured to sequentially combine short messages sent to or received from the telephone number based on time of occurring. The combination thereof is then stored in a memory of the cellular phone. In step 206, the cellular phone reads the combined short messages from the memory for reviewing the contents of all short messages of the telephone number. The contents of combined short messages are then shown sequentially on the display of the cellular phone. As an end, a user may easily know all short messages sent to or received from a telephone number through reviewing the contents of combined short messages shown on the display. The process ends immediately.

In step 207, while the typical short message showing mode is selected and performed, short messages sent to or received from any telephone numbers in the cellular phone (i.e., called party) are sequentially shown on the display of the cellular phone based on time of occurring for user reviewing. The process ends.

In brief, the invention enables a user to configure a cellular phone (i.e., called party) to sequentially combine short messages sent to or received from a telephone number based on time of occurring prior to storing. Hence, a user may review the combined short messages in a complete listing for quickly knowing the contents of all short messages according to a specific telephone number (i.e., calling party). As an end, the user may correctly send short messages in response to the received short messages without being confused by unprocessed short messages received from different calling parties.

While the invention has been described by means of specific embodiments, numerous modifications and variations could be made thereto by those skilled in the art without departing from the scope and spirit of the invention set forth in the claims.

1. A method of combining and showing short messages sent to or received from a telephone number, the method comprising the steps of:
configuring a cellular phone to sequentially combine short messages sent to or received from a telephone number based on time of occurring;
storing the combined short messages in a memory of the cellular phone;
reading the combined short messages from the memory for reviewing contents of all short messages of the telephone number; and
showing the contents of the combined short messages on a display of the cellular phone.

2. The method of claim 1, wherein the cellular phone comprises a combination option for selecting a short message combination and showing mode, the method further comprising the steps of:
configuring the cellular phone to sequentially combine short messages sent to or received from the telephone number based on time of occurring while the short message combination and showing mode being selected;
storing the combined short messages in the memory of the cellular phone; and
reading the combined short messages from the memory for reviewing contents of all short messages of the telephone number.
showing the contents of the combined short messages on the display; and

3. The method of claim 1, wherein the cellular phone comprises a typical short message showing mode, the method further comprising the steps of sequentially showing the short messages sent to or received from any telephone numbers on the display based on time of occurring while the typical short message showing mode being selected.

4. The method of claim 1, wherein the cellular phone comprises a control circuitry including:
a short message transceiver module activated by the cellular phone to send or receive the short messages;
a short message editing module for editing a short message;
a storage module as the memory of the cellular phone for storing the short messages sent or received by the cellular phone;
a display module as the display of the cellular phone for showing short messages sent or received by the cellular phone; and
a user setting module as the combination option for selecting the short message combination and showing mode or the typical short message showing mode.
